(19) United States
(12) Patent Application Publication
(10) Pub. No.: US 2025/0300985 A1
(43) Pub. Date: Sep. 25, 2025

(54) METHOD AND SYSTEM FOR MANAGING ACCESS TO A LOCAL APPLICATION LOCATED IN A COMPUTER NETWORK THAT DOES NOT SUPPORT AUTHENTICATION BY IDENTITY FEDERATION

(71) Applicant: BULL SAS, LES-CLAYES-SOUS-BOIS (FR)

(72) Inventor: Christophe GUIONNEAU, GRENOBLE (FR)

(73) Assignee: BULL SAS, LES-CLAYES-SOUS-BOIS (FR)

(21) Appl. No.: 19/046,862

(22) Filed: Feb. 6, 2025

(30) Foreign Application Priority Data
Feb. 14, 2024 (EP) 24305252.9

(51) Int. Cl. H04L 9/40; H04L 67/2895

(52) U.S. Cl. CPC H04L 63/101; H04L 63/102; H04L 67/2895

(57) ABSTRACT

The invention relates to a method (100) for managing access to a local application located in a computer network, said method (100) comprising an authentication phase (120) comprising the following steps:
authenticating (130) said user by an IDAAS server located outside said computer network;
in the event of successful authentication, generating (132) an authentication message comprising a first list of applications authorized for said user;
transmitting (134) said authentication message to a local authentication server located in said network; and
when said local application is mentioned in said first list, transmitting (142) an authorization data item associated with said user for said application, to a reverse proxy managing the access of said user to said application.

The invention further relates to a computer program and a system implementing such a method.

This application claims priority to European Patent Application Number 24305252.9, filed 14 Feb. 2024, the specification of which is hereby incorporated herein by reference.

### BACKGROUND OF THE INVENTION

### Field of the Invention

At least one embodiment of the invention relates to a method for managing access to an application, a called local application, located within a computer network that does not support authentication by identity federation. At least one embodiment of the invention also relates to a computer program and a system implementing such a method.

The field of one or more embodiments of the invention is the field of authentication of a user to an IDAAS server in order to access one or more local applications located in a computer network not offering authentication by identity federation.

### Description of the Related Art

Applications and services increasingly use authentication by identity federation. In short, the user authenticates to an authentication server, also known as an identity provider, and obtains a proof of authentication. This proof of authentication is then used to access several services/applications, avoiding the need for each user to authenticate individually for each service/application.

For users of a computer network, such as a corporate network, this authentication can be performed by a local identity provider, or an authentication server, located in said computer network. Another alternative is to use an identity provider in SaaS mode, called IDAAS for “Identity As A Service”, located on a server, called IDAAS server, external to the company's computer network.

However, not all applications in the corporate network support identity federation, and therefore the use of an IDAAS server: either because these applications do not support the protocols used for identity federation, such as the SAML, OIDC protocols, etc., or because these applications are applications which were originally intended for use only within the computer network. To use an identity federation solution with a local application that does not support identity federation, one solution consists of using a local authentication server and a reverse proxy arranged between said local application and said local authentication server. The reverse proxy exposes an access URL to the local application and the local authentication server manages authentication by identity federation in conjunction with an IDAAS server. Although this solution is widely used, it has a significant limitation: as seen from the IDAAS server, the reverse proxy is a single application, regardless of the number of applications managed by said reverse proxy.

To overcome this limitation, it is possible to instantiate several local authentication servers, each corresponding to an application. In addition to becoming complex to manage as the number of applications increases, this solution makes it impossible to use federated authentication for applications managed by different local authentication servers.

One aim of at least one embodiment of the invention is to solve at least one of the above-mentioned shortcomings.

Another aim of at least one embodiment of the invention is to propose a more efficient and less complex solution for authenticating a user to an IDAAS server in order to access a local application, that does not offer authentication by identity federation.

### BRIEF SUMMARY OF THE INVENTION

At least one embodiment of the invention makes it possible to achieve at least one of the above-mentioned aims by a method for managing access to an application, called local application, located within a computer network and not supporting authentication by identity federation, said method comprising an authentication phase comprising the following steps:
authenticating said user by an IDAAS server located outside said computer network;
in the event of successful authentication, generating an authentication message comprising:
   a list, called first list, of applications authorized for said user, and
   for each application, authorization data associated with said user;
transmitting said authentication message to a local authentication server, located in said computer network;
when said local application is mentioned in said first list, transmitting the authorization data associated with said user for said application to a reverse proxy managing the access of said user to said application.

Thus, one or more embodiments of the invention proposes a solution for using identity federation to access a local application that does not support authentication by identity federation. To achieve this, at least one embodiment of the invention proposes the use on the one hand of a reverse proxy associated with said local application and a local authentication server, and on the other hand an IDAAS server to authenticate the user according to an identification protocol by identity federation, such as for example the SAML protocol or the OIDC protocol.

In an innovative way, successful authentication of the user to the IDAAS server triggers the transmission, to the local authentication server, of an authentication message which comprises:
the list of all applications to which the user has access rights, and
for each of these applications, the access right assigned to the user for said application.
   This authentication message is sent to the local authentication server to authorize the user to access the local application or not.

In fact, the IDAAS server does not know which local application the user wants to access, since said local application does not support identity federation. Consequently, when the user is authenticated by the IDAAS server, said IDAAS server only knows the local authentication server and has no idea of the application the user wishes to access. This information is known only to the local authentication server. This server receives the list of all the applications to which the user has access rights, with the associated rights, and it is this local authentication server that can determine whether or not the user can access the local application to which he is requesting access.

Thus, it is possible to manage, with identity federation and with a same local authentication server, access to several local applications that do not support identity federation. With at least one embodiment of the invention, it is therefore not necessary to declare a local authentication server for each application, as is the case with prior art solutions, which is more efficient and less complex.

The application can be any type of application, such as for example an office application, an accounting application, an industrial design application, a finance application, a messaging application, etc.

The application can be accessed by an Internet browser using the URL of said application as displayed by the reverse proxy associated with said application. Alternatively, the application can be accessed by an access client wherein said URL is configured.

According to one or more embodiments, the method may comprise a step in which the user selects, or indicates, the local application he wishes to access.

This selection can be made in a variety of ways, for example by manually entering the URL of the application, by selecting a button associated with said application, by selecting a shortcut for said application, by selecting an icon for said application, etc.

According to at least one embodiment, the local application selection step can be performed before the authentication step.

In this case, the user indicates the local application he wishes to access before being authenticated by the IDDAS server.

In this case, the selection/indication of the local application can be made in different ways:
by entering a URL for the application into an Internet browser,
by selecting a button associated with said application or said URL,
by launching an access client to said local application;
etc.

In at least one embodiment, the method may comprise, following the step of selecting the local application, the following steps:
redirecting said user to the local authentication server, by the reverse proxy, and
redirecting said user to the IDAAS server, via the local authentication server;
   in order to perform the authentication step.

In at least one embodiment, these redirection steps take place before the authentication step to redirect the user to the IDAAS server for authentication.

These redirections can be carried out using a transaction identifier, or a session cookie, for keeping track of the user.

In at least one embodiment, the IDAAS server receives an authentication request from the IDAAS server. At this stage:
the IDAAS server does not know the application the user wishes to access, nor the user's identifier; and
the local authentication server does not necessarily know the user's identifier.
   The authentication request received from the local authentication server is linked to the domain of the local authentication server so that the IDAAS server only knows said domain of the local authentication server, as configured in the IDAAS server.

When authenticating to the IDAAS server, the user provides his identifier. When authentication is successful, the IDAAS server transmits the authentication message to the local authentication server, using the session cookie or transaction identifier for example. With the session cookie or transaction identifier, the local authentication server can then link the authentication message, and therefore the user, to the local application to which the user is requesting access.

The authentication server authorizes or denies said user access to said application based on the first list and the access rights given to said user, for each of the applications listed in the first list.

According to at least one embodiment, the local application selection step can be carried out after the authentication step, for example by selecting said local application on the IDAAS server.

In this case, the user first accesses the IDAAS server, for example by entering or selecting a URL for said IDAAS server.

Next, the authentication step is carried out: at this stage, the user has still not specified the local application he wishes to access. After the authentication step, the user has the option of indicating, or selecting, the local application, for example from the applications listed in the IDAAS server. At this stage, the authentication message is still not generated, and neither the reverse proxy nor the authentication server is aware of an access request.

According to one or more embodiments,, the method may comprise, following the step of selecting the local application, the following steps:
redirecting said user to the URL of said local application;
redirecting said user to the local authentication server, by the reverse proxy; and
redirecting said user to the IDAAS server, via the local authentication server;
   in order to perform the step of generating the authentication message.

In other words, once authenticated, the user accesses a page on the IDAAS server and can select, from all the applications associated with the local authentication server, the one he wishes to access. Following this selection, he is then redirected to the URL of the selected application, this URL address having been previously entered into said IDAAS server. This redirection is intercepted by the reverse proxy, which redirects the user to the local authentication server, which in turn redirects the user to the IDAAS server. All of these redirections are carried out using a session identifier, or a session cookie, placed in the user's Internet browser, allowing the IDAAS server to recognize the user when he is redirected to said IDAAS server.

Since the user has already authenticated to the IDAAS server, no further authentication is required. The IDAAS server recognizes the user and generates the authentication message which it transmits to the local authentication server

According to one or more embodiments, the authentication message may further comprise at least one of the following data:
a list, called second list, of applications associated with the domain of the local authentication server; and/or
an IDAAS server configuration version number.

At least one, or each, of these data items can be used by the IDAAS server for different functions.

Advantageously, at least one of these data items can be used to check synchronization between the IDAAS server and the local authentication server.

In fact, any change, for example a deletion or an addition, in the local applications managed by the local authentication server, in the users, or in the rights associated with a given user, etc., must be communicated to the IDAAS server, by updating the configuration of the IDAAS server with regard to said local authentication server. This update can be carried out by a synchronization that can be triggered as soon as a mismatch is detected between what is configured in the IDAAS server for the local authentication server, and the configuration at the level of said local authentication server.

This mismatch can be detected by comparing the second list as known in the IDAAS server, and as is configured in the local authentication server. If there is a difference between these two versions of the second list, a synchronization can be triggered between the local authentication server and the IDAAS server.

Alternatively, or in addition, this mismatch can be detected by comparing the version number of the IDAAS configuration as it is actually in the IDAAS server with the version number of the IDAAS configuration as it is known to the local authentication server. If there is a difference between these two numbers, a synchronization can be triggered between the local authentication server and the IDAAS server.

Before the authentication phase, the method according to the invention may further comprise a registration phase, the aim of which is to configure at least one of the components involved in implementing the invention.

According to one or more embodiments, the registration phase may comprise a step of declaring/configuring a reverse proxy for the local application. The declaration/configuration of a reverse proxy can be carried out in the conventional way, as known by the skilled person.

Alternatively, this step may be carried out upstream of the method according to one or more embodiments of the invention and may not form part of the method according to one or more embodiments of the invention.

According to one or more embodiments, the registration phase may further comprise a step of declaring the first list to the IDAAS server.

The first list can be communicated to the IDAAS server according to any suitable technique, for example:
by synchronizing the local authentication server with the IDAAS server,
by manual entry by an administrator,
by importing a configuration file,
etc.

Alternatively, this step may be carried out upstream of the method according to at least one embodiment of the invention and may not form part of the method according to at least one embodiment of the invention.

According to one or more embodiments, the registration phase may further comprise a step of declaring the second list to the IDAAS server.

The second list can be communicated to the IDAAS server according to any suitable technique, for example:
by synchronizing the local authentication server with the IDAAS server,
by manual entry by an administrator,
by importing a configuration file,
etc.

Alternatively, this step may be carried out upstream of the method according to at least one embodiment of the invention and may not form part of the method according to at least one embodiment of the invention.

The registration phase may comprise a step of registering the local authentication server with the IDAAS server to implement an identity federation mechanism. This registration step can be carried out in the conventional way, in accordance with a SAML or OIDC protocol.

According to at least one embodiment, an IDAAS client administrator logs on to his IDAAS instance and to the IDAAS configuration interface. The administrator declares the local authentication server by means of a configuration stepper wherein he enters the technical data of said local authentication server, such as the name of its instance. In return, he obtains an API key and a configuration URL specific to his local authentication server instance. The administrator enters the configuration URL and the API key in the configuration interface of the local authentication server, and triggers autoconfiguration of the SAML, or optionally OIDC, federation link between said local authentication server and the IDAAS server. During autoconfiguration, the local authentication server exchanges SAML metadata with the IDAAS server and obtains SAML metadata from the IDAAS server. The SAML federation relationship is established.

The principle would be similar with the OIDC protocol.

According to one or more embodiments, the reverse proxy can be dedicated to the local application. In this case, the reverse proxy is used only for said local application.

According to one or more embodiments, the reverse proxy can be shared by the local application and at least one other local application. In this case, the reverse proxy executes a URL rewriting mechanism configured to add a URL prefix for each of said local applications. Such a reverse proxy is known to the skilled person.

In a network comprising several local applications for which access is managed according to the invention, the method according to at least one embodiment of the invention can use:
at least one reverse proxy dedicated to one of the local applications, and
at least one reverse proxy shared by at least two of the local applications.

According to at least one embodiment of the invention, a computer program is proposed comprising computer instructions, which when executed by a computer, implement the steps of the method according to one or more embodiments of the invention.

The computer program can be in machine language, in C, C++, JAVA, Python, and more generally any type of computer language.

The computer program can be a single program, or a set of several programs communicating together. For example, in at least one embodiment, the computer program can comprise an IDAAS module executed on the IDAAS server and a local module executed on the local authentication server.

According to at least one embodiment of the invention, a system is proposed for managing access to an application, called local application, located within a computer network and that does not support authentication by identity federation, said system comprising:
a local authentication server in said computer network,
a reverse proxy in said computer network, and
an IDAAS server;
   configured to implement all the steps of the method according to the invention.

The system according to one or more embodiments of the invention may comprise, in terms of technical, hardware and/or software means, at least one, or any combination of at least two, of the features described hereinbefore with reference to the method according to at least one embodiment of the invention, and which are not mentioned herein for brevity.

### BRIEF DESCRIPTION OF THE DRAWINGS

Other benefits and features shall become evident upon examining the detailed description of an entirely non-limiting embodiment, and from the enclosed drawings in which:

FIG. 1 is a schematic depiction of a non-limiting example embodiment of a method according to one or more embodiments of the invention;

FIG. 2 is a schematic depiction of another non-limiting example embodiment of a method according to one or more embodiments of the invention; and

FIG. 3 is a schematic depiction of a non-limiting example embodiment of a system according to one or more embodiments of the invention.

### DETAILED DESCRIPTION OF THE INVENTION

It is clearly understood that the one or more embodiments that will be described hereafter are by no means limiting. In particular, it is possible to imagine variants of the one or more embodiments of the invention that comprise only a selection of the features disclosed hereinafter in isolation from the other features disclosed, if this selection of features is sufficient to confer a technical benefit or to differentiate the one or more embodiments of the invention with respect to the prior state of the art. This selection comprises at least one preferably functional feature which lacks structural details, or only has a portion of the structural details if that portion only is sufficient to confer a technical benefit or to differentiate the one or more embodiments of the invention with respect to the prior state of the art.

In the figures, the same reference has been used for the features that are common to several figures.

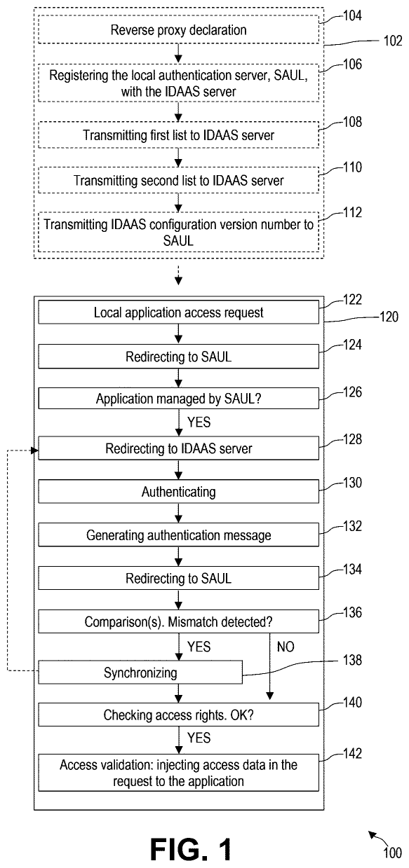

FIG. 1 is a schematic depiction of a non-limiting example of a method according to one or more embodiments of the invention.

The method 100, depicted in FIG. 1, can be implemented to authenticate a user with an IDAAS server in order to authorize said user, via an identity federation mechanism, to access a local application:
located in a given computer network, for example a corporate network, in particular hosted on an application server located in said computer network; and
that does not manage authentication by identity federation.

The method 100 optionally comprises a registration phase 102 for configuring at least one of the components used to implement said method, by way of at least one embodiment of the invention.

The registration phase 102 can comprise an optional step 104 to configure a reverse proxy, which may or may not be dedicated, for each local application. The declaration/configuration of a reverse proxy can be carried out in the conventional way, as known by the skilled person.

The reverse proxy is declared to the local authentication server, SAUL, which manages access to this application.

If access management by identity federation is desired for this application, the name of the application is added to a list, a called second list, indicating all local applications for which the SAUL implements access management by identity federation.

Preferably, the URL of the local application, as exposed by the reverse proxy, can also be entered. This URL can be a URL pointing directly to the exposed URL of the application, through the reverse proxy, or to an intermediate home page hosted by the reverse proxy. If no address is entered, then no link will be displayed on the IDAAS home page for the user, but the application will still be taken into account and protected if the user knows the URL by another means.

This second list can be modified at any time to add/remove an application, for example by a SAUL administrator. For example, a new local application can be added. A local application whose name was on the list can be removed: for this application, the SAUL can perform conventional authentication, without identity federation.

The registration phase 102 can comprise an optional step 106 of registering the local authentication server, SAUL, with the IDAAS server to implement an identity federation mechanism. This registration step can be carried out in the conventional way, in accordance with a SAML or OIDC protocol.

According to at least one embodiment, an IDAAS client administrator logs on to his IDAAS instance and to the IDAAS configuration interface. The administrator declares the SAUL via a configuration stepper wherein he enters the technical data of said SAUL, such as the name of its instance. In return, he obtains an API key and a configuration URL specific to his SAUL instance. The administrator enters the configuration URL and the API key in the configuration interface of the SAUL, and triggers autoconfiguration of the SAML, or optionally OIDC, federation link between said SAUL and the IDAAS. During autoconfiguration, the SAUL exchanges SAML metadata with IDAAS and obtains SAML metadata from IDAAS. The SAML federation relationship is established. The principle would be similar with the OIDC protocol.

The registration phase 102 can comprise an optional step 108 for transmitting to the IDAAS server the first list indicating to the IDAAS server all the applications for which the user has access rights. For each application, the nature and/or level of access rights can be specified. This first list can be communicated to the IDAAS server according to any suitable technique, for example:
by synchronizing the SAUL with the IDAAS server,
by manual entry by an administrator,
by importing a configuration file,
etc.

This first list can be modified at any time, for example by changing the configuration of the IDAAS server. The IDAAS server configuration number is communicated and stored in the SAUL.

The registration phase 102 comprises an optional step 110 of declaring, to the IDAAS server, the second list of applications associated with the SAUL and for which authentication by identity federation is performed. This second list can be communicated to the IDAAS server according to any suitable technique, for example:
by synchronizing the local authentication server with the IDAAS server,
by manual entry by an administrator,
by importing a configuration file,
etc.

When the SAUL configuration on the IDAAS server is complete, when the lists have been transmitted to the IDAAS server, etc., a SAUL configuration version number on the IDAAS server can be communicated to the SAUL, during an optional step 112. This version number is changed each time the SAUL configuration on the IDAAS server is modified, for example when:
the second list is modified,
the first list is modified,
a user's access right is changed,
etc.

The registration phase 102, and each of steps 104-112, is optional as it can be carried out upstream of the method 100 according to one or more embodiments of the invention and not form part of the method according to one or more embodiments of the invention.

In addition, steps 104-112 can be performed in any order other than that described hereinbefore, by way of at least one embodiment.

The method 100 further comprises a phase 120 for authenticating a user with a view to accessing the local application, or one of the local applications, managed by the SAUL and associated with the SAUL domain in the IDAAS server.

In the example depicted on FIG. 1, according to at least one embodiment of the invention, during step 122, the user issues a request to access said application, before authenticating himself to the IDAAS server.

For example, in one or more embodiments, the user enters the URL of the local application as presented by the reverse proxy. The URL can be entered manually, by selecting a shortcut button, in an Internet browser executed on a user device, or else by launching an access client installed and executed on said user device. This access request generates a session cookie, or a transaction identifier, or any other session identifier that identifies the session started by the user in order to access the local application.

The access request is intercepted by the reverse proxy during step 124 and redirected to the local authentication server, SAUL.

The redirection is received by the SAUL during step 126. During this step, the SAUL consults the second list indicating the local applications for which it performs authentication with identity federation.

If the local application is not included on the second list, the access request is rejected. If the local application is included on the second list, the SAUL redirects the browser/access client to a page of the IDAAS server, during step 128

During step 130, the user identifies himself to the IDAAS server, according to the identification technique, or one of the techniques, supported by the IDAAS server.

If identification is unsuccessful, the access request is rejected. If identification is successful, the IDAAS server generates, during step 132, an authentication message comprising a proof of authentication, and the first list indicating:
the authorized applications for said user, and
for each application, authorization data associated with said user, such as for example data indicating an access right granted to the user for said application.

Optionally, the authentication message may further comprise:
the second list of applications for which the SAUL manages authentication by identity federation, and/or
the SAUL configuration version number in the IDAAS server.
   At least one of these data items can be used to detect a configuration mismatch between the local authentication server, SAUL, and as configured in the IDAAS server and trigger synchronization of said servers therebetween, to compensate for said configuration mismatch.

During step 134, the user, that is to say the browser or application client thereof, is redirected to the SAUL server with the authentication message.

During optional step 136, the SAUL compares:
the second list in the authentication message received to the second list as stored in said SAUL; and/or
the configuration version number to the configuration version number stored in the SAUL.

If a mismatch is found in at least one of these comparisons, this means that there is a mismatch between the actual SAUL configuration and that stored in the IDAAS server.

In this case, during optional step 138, the SAUL triggers a synchronization between the SAUL server and the IDAAS server to compensate for the mismatch detected during step 136.

Following the synchronization, the SAUL can optionally redirect the user to the IDAAS server for re-authentication. In this case, the method resumes at step 130.

During step 140, the SAUL checks whether the local application the user wants to access is one of the applications listed in the first list, and if so, the access right assigned to the user for this application.

If this is not the case, the access request is rejected.

If this is the case, the SAUL injects the authorization data into the requests to the application downstream of the reverse proxy, so that the user can access the local application, during step 142.

Of course, by way of one or more embodiments, the method 100 can comprise other steps than those described herein. In one or more embodiments, one or more of the steps indicated as optional may be performed, or ignored.

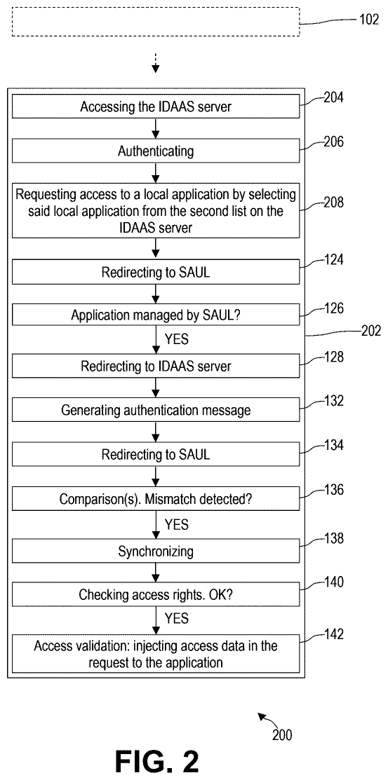

FIG. 2 is a schematic depiction of a non-limiting example of a method according to one or more embodiments of the invention.

The method 200, depicted in FIG. 2, can be implemented to authenticate a user with an IDAAS server in order to authorize said user, via an identity federation mechanism, to access a local application:
located in a given computer network, for example a corporate network, for example hosted on an application server located in said computer network; and
that does not manage authentication by identity federation.

The method 200 can comprise the optional registration phase 102.

The method 200 further comprises an authentication phase 202 that is different with respect to authentication phase 120 of the method 100 in FIG. 1, according to at least one embodiment of the invention.

In method 200, the authentication phase 202 comprises a step 204 in which the user accesses the IDAAS server, for example by entering a URL for said IDAAS server in an Internet browser executed by the user device. During step 204, the user accesses the IDAAS server without going through the reverse proxy or the SAUL, unlike the method 100 of FIG. 1.

Then, during step 206, the user is authenticated on the IDAAS server in a similar or identical way to step 130 of the method 100 of FIG. 1, according to at least one embodiment of the invention. At this stage, it is not yet known which local application the user wants to access.

When authentication is successful, the user accesses, during step 208, a list of applications for which the SAUL manages access by identity federation, namely the second list. From this second list, the user selects the local application he wishes to access. This selection acts as a request for access to said local application. The selection of the application directs the user, and in particular his browser, to the reverse proxy during step 208.

Steps 124-128 are then performed to redirect the user from the reverse proxy to the SAUL, then from the SAUL to the IDAAS server.

When the user returns to the IDAAS server, and given that the user has already been authenticated during step 206, no further authentication is required and the IDAAS server recognizes said user, for example by a session cookie or a transaction identifier.

The authentication message is generated during step 132, then steps 134-142, as described hereinbefore, are performed.

The methods 100 and 200 comprise an optional registration phase 102, which can be carried out upstream of the method and not form part of methods 100 and 200, according to at least one embodiment of the invention.

Furthermore, if required, the registration phase 102 can be carried out just before an authentication phase 120, respectively 202, so that said authentication phase 120, respectively 202, is implemented immediately after, or upon completion of, said registration phase 102. Alternatively, the registration phase 102 can be carried out well before authentication phase 120, respectively 202, so that said authentication phase 120, respectively 202, is not implemented immediately after, or upon completion of, said registration phase 102 and a non-negligible amount of time elapses between the end of said registration phase 102 and said authentication phase 120, respectively 202.

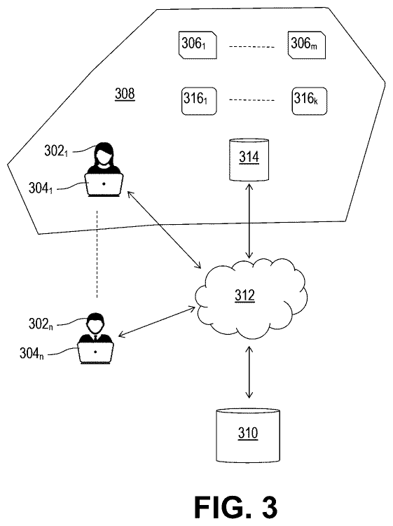

FIG. 3 is a schematic depiction of a non-limiting example of a system according to one or more embodiments of the invention.

The system 300 depicted in FIG. 3, can be used to implement a method according to the invention and in particular, method 100 of FIG. 1 or method 200 of FIG. 2, according to at least one embodiment of the invention.

The system 300, depicted in FIG. 3, can be used to manage the access of users 302₁-302ₙ using user devices 304₁-304ₙ, to one or more local applications 306₁-306ₘ located in a computer network 308. At least one local application 306ᵢ can be executed on a server (not shown) located on the network 308. At least some of the users 302₁-302ₙ wishing to access local applications 306₁-306ₘ, and therefore at least some of the devices 304₁-304ₙ, can be located within the network 308 or outside the network 308.

The system 300 comprises an IDAAS server 310 located outside the local network 308 and communicating with said local network 308 via a communication network 312, such as for example the Internet.

The system 300 further comprises a local authentication server, SAUL, 314, located in network 308.

In addition, the system 300 further comprises one or more reverse proxies 316₁-316ₖ associated with local applications 306₁-306ₖ and located between SAUL 314 and said local applications 306₁-306ₖ. According to one or more embodiments, each reverse proxy 316ᵢ is dedicated to a single local application 306ᵢ: in this case k=m. According to one or more embodiments, at least one reverse proxy 316ᵢ can be associated with several of the local applications 306₁-306ₖ: in this case k<m.

The components of the system 300 are configured to implement the method according to the invention, and in particular method 100 of FIG. 1 or method 200 of FIG. 2, according to at least one embodiment of the invention.

Of course, the system 300 may comprise components other than those described herein, according to at least one embodiment of the invention.

Of course, the at least one embodiment of the invention is not limited to the detailed examples described hereinbefore. Numerous variants can be envisaged for these examples without departing from the scope of the invention as defined in the main claims, according to at least one embodiment of the invention.

1. A method for managing access to a local application, located within a computer network and not supporting authentication by identity federation, said method comprising:
an authentication phase comprising:
authenticating a user by an Identity As A Service (IDAAS) server located outside said computer network;
in an event of successful authentication, generating an authentication message that comprises
a first list, of applications authorized for said user, and
for said local application, authorization data associated with said user;
transmitting said authentication message to a local authentication server, located in said computer network; and
when said local application is mentioned in said first list, transmitting the authorization data associated with said user for said local application to a reverse proxy managing access by said user to said local application.

2. The method according to claim 1, further comprising selecting, or indicating, by the user of the local application.

3. The method according to claim 2, wherein said selecting the local application is carried out before the authenticating, by entering or selecting a URL of said local application.

4. The method according to claim 3, further comprising, following the selecting the local application,
redirecting said user to the local authentication server, by the reverse proxy,
redirecting said user to the IDAAS server, by the local authentication server;
in order to perform the authenticating.

5. The method according to claim 2, wherein the selecting the local application is carried out after the authenticating, for by selecting said local application on the IDAAS server.

6. The method according to claim 5, further comprising, following the selecting the local application,
redirecting said user to a URL of said local application,
redirecting said user to the local authentication server, by the reverse proxy,
redirecting said user to the IDAAS server, by the local authentication server;
in order to carry out the generating the authentication message.

7. The method according to claim 1, wherein the authentication message further comprises data items comprising at least one of:
a second list of applications associated with domain of the local authentication server,
an IDAAS server configuration version number;
wherein at least one of the data items is used to check synchronization between the IDAAS server and the local authentication server.

8. The method according to claim 1, further comprising, prior to the authentication phase, a registration phase comprising configuring the reverse proxy for the local application.

9. The method according to claim 8, wherein the registration phase further comprises declaring the first list to the IDAAS server.

10. The method according to claim 8, wherein the registration phase further comprises a declaring a second list to the IDAAS server.

11. The method according to claim 1, wherein the reverse proxy is dedicated to the local application, or
is shared by the local application and at least one other local application, said reverse proxy executing a URL rewriting mechanism configured to add a URL prefix for said local application

12. A computer program comprising computer instructions, which when executed by a computer, implement a method for managing access to a local application, located within a computer network and not supporting authentication by identity federation, said method comprising:
an authentication phase comprising
authenticating a user by an Identity As A Service (IDAAS) server located outside said computer network;
in an event of successful authentication, generating an authentication message that comprises
a first list, of applications authorized for said user, and
for said local application. authorization data associated with said user;
transmitting said authentication message to a local authentication server, located in said computer network; and
when said local application is mentioned in said first list, transmitting the authorization data associated with said user for said local application to a reverse proxy managing access by said user to said local application.

13. A system that manages access to a local application located within a computer network and not supporting authentication by identity federation, said system comprising:
a local authentication server in said computer network,
at least one reverse proxy in said computer network, and
an IDAAS server an Identity As A Service (IDAAS) server;
configured to implement
an authentication phase comprising
authenticating a user by said IDAAS server located outside said computer network;
in an event of successful authentication, generating an authentication message that comprises
a first list, of applications authorized for said user, and
for said local application, authorization data associated with said user;
transmitting said authentication message to the local authentication server, located in said computer network; and
when said local application is mentioned in said first list, transmitting the authorization data associated with said user for said local application to said at least one reverse proxy managing access by said user to said local application.
